(19) United States
(12) Patent Application Publication
(10) Pub. No.: US 2011/0167249 A1
(43) Pub. Date: Jul. 7, 2011

(54) COMPUTER SYSTEM AND METHOD CAPABLE OF REMOTELY RESTORING OPERATING SYSTEM

(75) Inventor: Jang-hwan AHN, Gyeonggi-do (KR)

(73) Assignee: SAMSUNG ELECTRONICS CO., LTD., Gyeonggi-Do (KR)

(21) Appl. No.: 12/845,078

(22) Filed: Jul. 28, 2010

(30) Foreign Application Priority Data
Jan. 6, 2010 (KR) 10-2010-0000890

(51) Int. Cl. G06F 15/177

(52) U.S. Cl. 713/2

(57) ABSTRACT

A computer system and a method for remotely restoring, upgrading, or booting an operating system (O.S). A communication unit communicates with an external device in which a restoring image of the operating system is stored. A user's input request for initialization, causes a controller to perform an initialization according to a power-on input, including checking whether or not a request for restoring the O.S. has been received from a user prior to starting a boot of the operating system. If a request for restoring the operating system is received, the restoring image stored in the external device is accessed through the communication unit to restore the operating system installed in the computer system.

### CLAIM OF PRIORITY

This application claims priority from Korean Patent Application No. 10-2010-0000890, filed on Jan. 6, 2010 in the Korean Intellectual Property Office, the disclosure of which is incorporated herein by reference in its entirety.

### BACKGROUND OF THE INVENTION

1. Field of the Invention

The present invention relates to computer systems and methods for restoring, upgrading, or booting an operating system. More particularly, the present invention relates to a system and method that can remotely control the aforementioned actions.

2. Description of the Related Art

With the recently-developed portable, slim, and light-weight trend of computers, portable computers such as laptop computers without optical disc drives (ODD) have become popular.

However, when an error is generated in an operating system of such a portable computer having no ODD, it is difficult to restore the operating system unless a program for restoring the operating system is stored on a hard disk drive thereof. In the meantime, since such a restoring program typically takes up a significantly large amount of storage space because of its complexity, it would preferable if such a large-capacity restoring program was not stored within a storage of the portable computer, as the recent trend is towards becoming slimmer and more light-weight. Furthermore, when an error is generated in the operating system of the portable computer having no ODD, it is difficult to boot the operating system.

It is also difficult to upgrade the operating system of the portable computer having no ODD.

### SUMMARY OF THE INVENTION

Accordingly, the present invention provides a computer system and a method, for remotely restoring an operating system in a computer system that does not have an ODD.

Another exemplary embodiment is to provide a computer system and a method for remotely upgrading an operating system in a computer system that does not have an ODD.

Still another exemplary embodiment is to provide a computer system and a method for remotely booting an operating system in a computer system that does not have an ODD.

According to an exemplary embodiment of the present invention, there is provided a computer system without an ODD whose operating system is capable of being remotely restored, the system including: a storage where the operating system is installed; a communication unit which communicates with an external device in which a restoring image of the operating system is stored; a user input unit which receives a user's input; and a controller which performs an initialization of the computer system according to a power-on input, checks whether or not a request for restoring the operating system is received from a user before starting to boot the operating system installed in the storage following the power-on input, and, if the request for restoring the operating system is received, accesses the restoring image of the operating system stored in the external device through the communication unit to restore the operating system installed in the computer system by using the restoring image of the operating system.

If a predetermined key is input from the user input unit, the controller checks whether the request for restoring the operating system has been received.

The computer system further preferably includes a display unit, wherein the controller forms an input menu for inputting the request for restoring the operating system and controls the display unit to display the formed input menu, and the controller checks whether or not the request for restoring the operating system is received if the request for restoring the operating system is input by use of the displayed input menu.

The computer system further preferably includes a display unit, wherein, if the request for restoring the operating system is received, the controller controls the display unit to display device information related to a predetermined external device in which a restoring image of the operating system is stored.

In an exemplary aspect of the present invention, if device information related to an external device in which a restoring image of the operating system is stored is input through the user input unit, the controller determines the external device in which a restoring image of the operating system is stored, based on the inputted device information.

According to another exemplary embodiment of the present invention, there is provided a method of remotely restoring an operating system of a computer system, the method preferably comprising: performing an initialization of the computer system according to a power-on input; checking whether or not a request for restoring the operating system is received from a user before starting to boot the operating system installed in the computer system following the power-on input; accessing the restoring image of the operating system stored in the external device through the communication unit if the request for restoring the operating system is received; and restoring the operating system installed in the computer system by using the restoring image of the operating system.

The checking step preferably comprises checking that the request for restoring the operating system is received if a predetermined key is inputted from the user input unit.

The method may further comprise displaying an input menu for inputting the request for restoring the operating system; and selecting the request for restoring the operating system is received by using the displayed input menu.

The accessing step comprises displaying device information related to a predetermined external device in which a restoring image of the operating system is stored.

The accessing step may also comprise determining the external device in which a restoring image of the operating system is stored, based on device information inputted by a user.

According to another exemplary embodiment of the present invention, there is provided a computer system whose operating system is capable of being remotely upgraded, the system including: a storage where the operating system is installed; a communication unit which communicates with an external device in which a restoring image of the operating system is stored; a user input unit which receives a user's input; and a controller which performs an initialization of the computer system according to a power-on input, checks whether or not a request for upgrading the operating system is received from a user before starting to boot the operating system installed in the storage following the power-on input, and, if the request for upgrading the operating system is received, accesses the upgrading image of the operating system stored in the external device through the communication unit to upgrade the operating system installed in the computer system by using the upgrading image of the operating system.

According to yet another exemplary embodiment of the present invention, there is provided a method of remotely upgrading an operating system of a computer system, the method preferably comprising: performing an initialization of the computer system according to a power-on input; checking whether or not a request for upgrading the operating system is received from a user before starting to boot the operating system installed in the computer system following the power-on input; accessing the upgrading image of the operating system stored in the external device through the communication unit if the request for upgrading the operating system is received; and restoring the operating system installed in the computer system by using the upgrading image of the operating system.

According to still another exemplary embodiment of the present invention, there is provided a computer system whose operating system is capable of being remotely booted, the system preferably including: a storage where the operating system is installed; a communication unit which communicates with an external device in which a restoring image of the operating system is stored; a user input unit which receives a user's input; and a controller which performs an initialization of the computer system according to a power-on input, accesses the booting image of the operating system stored in the external device through the communication unit if a predetermined key is inputted from a user before starting to boot the operating system installed in the storage following the power-on input, and boots the computer system by using the booting image of the operating system stored in the external device.

According to another exemplary embodiment of the present invention, there is provided a method of remotely booting an operating system of a computer system, the method comprising: performing an initialization of the computer system according to a power-on input; receiving a predetermined key from a user before starting to boot the operating system installed in the computer system following the power-on input; accessing the booting image of the operating system stored in the external device through the communication unit; and booting the computer system by using the booting image of the operating system stored in the external device.

### BRIEF DESCRIPTION OF THE DRAWINGS

The above and/or other exemplary aspects will become apparent and more readily appreciated by a person of ordinary skill in the art from the following description of the exemplary embodiments, taken in conjunction with the accompanying drawings, in which:

FIG. 1 is a block diagram showing a structure of a computer system in accordance with an exemplary embodiment of the present invention;

FIG. 2 is a block diagram showing a more detailed structure of a computer system in accordance with the exemplary embodiment of the present invention;

FIG. 3 is a flowchart showing a control process for remotely restoring an operating system in accordance with the exemplary embodiment of the present invention; and

FIG. 4 is a flowchart showing a control process for remotely restoring an operating system in accordance with the exemplary embodiment of the present invention.

### DETAILED DESCRIPTION

Below, exemplary embodiments of the present invention will now be described in detail with reference to accompanying drawings so as to be easily realized by a person having ordinary skill in the art. The present inventive concept may be embodied in various forms and the appended claims are not limited to the exemplary embodiments set forth herein. Descriptions of well-known structures and functions may be omitted for clarity when their inclusion could obscure appreciation of the subject matter of the present invention by the artisan, and like reference numerals refer to like elements throughout.

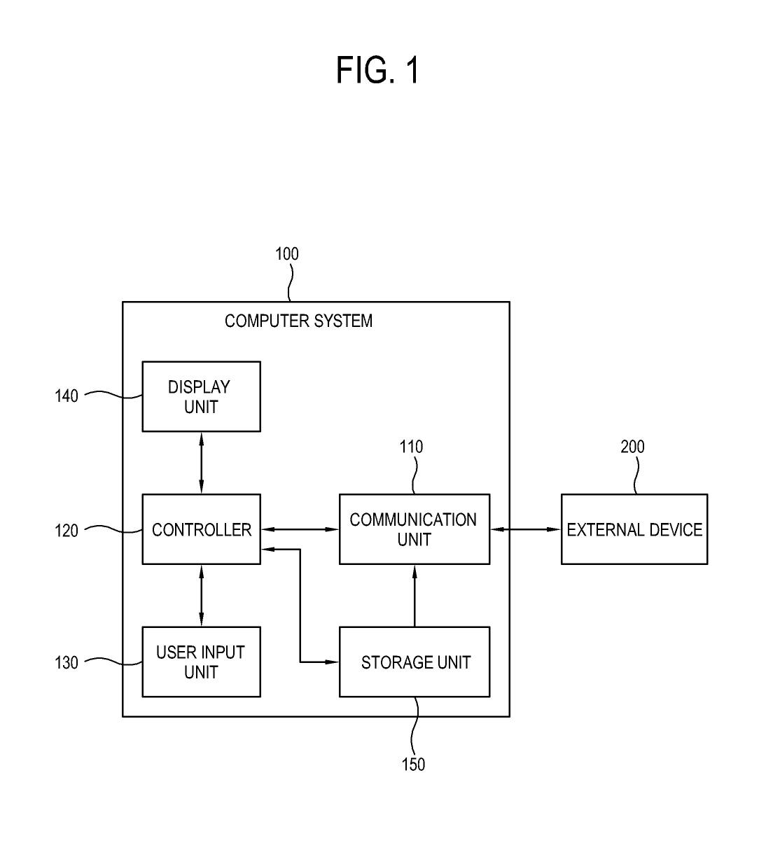

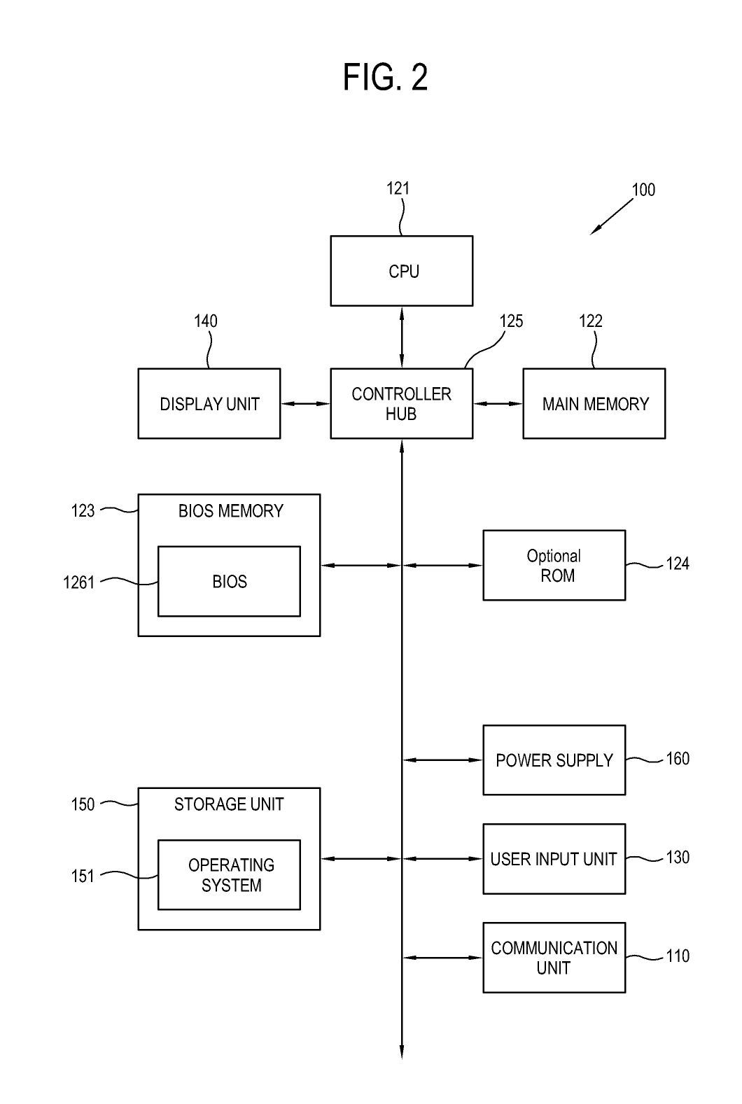

FIG. 1 is a block diagram showing a structure of a computer system 100 in accordance with an exemplary embodiment of the present invention, and FIG. 2 is a block diagram showing a more detailed structure of the computer system 100 in accordance with the exemplary embodiment.

As shown in FIG. 1, the computer system 100 may include a communication unit 110, a controller 120, a user input unit 130, a display unit 140, and a storage 150. The computer system 100 may communicate with an external device 200 through the communication unit 110.

The computer system 100 may be embodied, for example, as a personal computer (PC) such as a desk top, tablet, or a laptop computer, just for a few non-limiting examples. In addition to such a typical PC, the computer system 100 may include any device having functions similar to those of the PC, such as a smart book, a mobile Internet device (MID), a net book, PDA, etc. Preferably, the computer system 100 may include a computer system having no optical disc drive (ODD), e.g., a drive for CD-R, CD-RW, DVD, or BD. The device may have a magnetic disk drive, but preferably not a magneto-optical (MO) disk drive.

The communication unit 110 may, for example, communicate with the external device 200 through a network. Especially, the external device 200 may include an external device having a restoring image, an upgrading image, or a booting image of an operating system of the computer system 100. Accordingly, the communication unit 110 may be embodied as, for example, a network card or a network chip which communicates with the external device 200 through a network.

Here, the network may include a wire or a wireless network. Specifically, the network may also comprise a local area network (LAN) or a wireless local area network (WLAN). Accordingly, the communication unit 110 may comprise a communication module for the LAN or the WLAN.

Here, the external device 200 may include an electronic device that can communicate over a network with the communication unit 110, such as a desk top, tablet computer or a lap-top or notebook computer. Preferably, the external device 200 may include a PC having an ODD. If the external device 200 has an ODD and is capable of the network communication with the communication unit 110, the external device 200 may be set to share the ODD with the computer system 100. In addition, if the external device 200 shares the ODD, the external device 200 may set a specific IP of a private IP area for itself.

The communication unit 110 may further include a connection portion (not shown) for being connected to a cable or antenna for data transmission and reception with the external device 200. Accordingly, the communication unit 110 may transmit and receive data to and from the external device 200 by using a wire cable (e.g., an USB cable) instead of performing the network communication. Therefore, the communication unit 110 may further include a communication module for the data transmission and reception.

Still referring to FIG. 1, the ODD included in the external device 200 may activate an optical disk on which a restoring image of the operating system is stored or stores an ISO file of the restoring image of the operating system. Accordingly, if the ODD is shared, the restoring image of the operating system may be shared by the activation of the optical disk on which the restoring image of the operating system is stored, or the ISO file of the restoring image of the operating system may be shared.

Similarly, the ODD included in the external device 200 may activate an optical disk on which an upgrading image of the operating system is stored or store an ISO file of the upgrading image of the operating system. Accordingly, if the ODD is shared, the upgrading image of the operating system may be shared by the activation of the optical disk on which the upgrading image of the operating system is stored, or the ISO file of the upgrading image of the operating system may be shared. Since most operating system from time to time have updates, the set-up would allow for both updates and upgrades of the operating system. Similarly, the ODD included in the external device 200 may activate an optical disk on which a booting image of the operating system is stored, or store an ISO file of the booting image of the operating system. Accordingly, if the ODD is shared, the booting image of the operating system may be shared by the activation of the optical disk on which the booting image of the operating system is stored, or the ISO file of the booting image of the operating system may be shared.

The user input unit 130 may receive a user's input. To that end, the user input unit 130 may be embodied as a peripheral device in a plurality of ways, such as a keyboard or a mouse, a button on the computer system 100, or a touch screen having a touch panel. Accordingly, the user input unit 130 may receive a power-on input of the computer system 100 and a key input of the computer system 100.

The display unit 140 may perform a function for displaying an operation of the computer system 100 to a user. To that end, the display unit 140 may include a graphic processing unit such as a graphic card and a display module such as a LCD monitor, or any other type of thin-film display technology.

The storage 150 may store the operating system of the computer system 100. Preferably, the storage 150 may be embodied as a hard disk drive (i.e. a magnetic disk drive). The operating system, which is a program for managing resources of hardware and software of the computer system 100, may perform main memory allotment, file management, input output control of a device, execution control of a program such as a communication program, and the like. For example, the operating system may include, for example, Microsoft's Windows©, Apple's Macintosh OS©, or the like.

The controller 120 may perform an initialization of the computer system 100 according to the power-on input and check whether or not a request for restoring the operating system is received from a user before starting to boot the operating system installed in the storage 150 following the power-on input. If the request for restoring the operating system is received, the controller 120 may access a restoring image of the operating system stored in the external device 200 through the communication unit 110 and restore the operating system installed in the computer system 100 by using the restoring image thereof.

If a predetermined key is input through the user input unit 130, the controller 120 may check that the request for restoring the operating system has been received. The aforementioned exemplary embodiment may be applied to the case of a request for upgrading the operating system.

In addition, the controller 120 may form an input menu for inputting a request for restoring the operating system and display the formed input menu through the display unit 140. For example, the controller 120 may form an input menu for inputting a request of restoring the operating system in a BIOS CMOS setting menu and display the formed input menu through the display unit 140, to thereby enable a user to input the request of restoring the operating system. The aforementioned exemplary embodiment may be applied to the case of a request for upgrading the operating system.

In accordance with an exemplary embodiment of the present invention, if the request for restoring the operating system is received, the controller 120 may access a restoring image of the operating system stored in a predetermined external device through the communication unit 110. In this case, the controller 120 may display device information related to the predetermined external device, e.g., an IP address of the external device, through the display unit 140. The aforementioned example may be applied to the case of a request for upgrading the operating system.

Similarly, if the displayed device information related to the predetermined external device is changed through the user input unit 130, the controller 120 may access a restoring image of the operating system stored in a changed external device through the communication unit 110.

Similarly, if the displayed device information related to the predetermined external device is input through the user input unit 130, the controller 120 may determine whether or not an external device in which a restoring image of the operating system is stored, based on the input device information.

The operation of the controller 120 may identically be applied to the case of upgrading/booting the operating system of the computer system. For example, the controller 120 may perform the initialization of the computer system 100 according to the power-on input and then check whether or not a request for upgrading the operating system has been received from a user before starting to boot the operating system installed in the storage 150 following the power-on input. If the request for upgrading the operating system is received, the controller 120 may then access an upgrading image of the operating system stored in the external device 200 through the communication unit 110 and upgrade the operating system installed in the computer system 100 by using the upgrading image thereof.

Similarly, the controller 120 may also perform the initialization of the computer system 100 according to the power-on input request and, if a predetermined key is input by a user before starting to boot the operating system installed in the storage 150 following the power-on input (e.g. a programmed function (PF or F# key), access a booting image of the operating system stored in an external device through the communication unit 110 to boot the computer system by using the booting image of the operating system stored in the external device.

As shown in FIG. 2, the controller 120 of the present exemplary embodiment may preferably include a central processing unit (CPU) 121, a main memory 122, a BIOS memory 123, an optional ROM 124, and a controller hub 125.

The CPU 121, which controls a general operation of the computer system 100, may execute a code copied in the main memory 122 and perform a command corresponding to the code. In other words, the CPU 121 may perform a command for controlling at least one of the storage 150, the display unit 140, a peripheral device (not shown), and the controller hub 125).

The main memory 122 may copy therein both the code executed by the CPU 121 and store therein data related to the performance of a corresponding command. The main memory 122 may be embodied as, for example, a volatile memory, e.g., a double-data-rate synchronous dynamic random access memory.

The BIOS memory 123 may store a code of a BIOS 1261. When the computer system 100 is turned on, the BIOS 1261 may be copied in the main memory 122, thereby allowing the CPU 121 to perform an initialization of the computer system 100. The initialization of the computer system 100 may include a power on self-test (POST). The BIOS memory 123 may be embodied as a nonvolatile memory such as a ROM, a PROM, an EPPROM, and a flash memory.

The optional ROM 124 may store an application program for a network booting to be executed by the BIOS 1261. The CPU 121 may perform the initialization of the computer system 100 by the BIOS 1261 according to the power-on input. Before starting to boot an operating system 151 installed in the storage 150, i.e., before the start of a booting section of the operating system 151 following the power-on input, if a specific key (including but not limited to a function key or combination of keys) for the request of restoring (or upgrading) the operating system is inputted from a user through the user input unit 130, the BIOS 1261 may execute an application program for network booting stored in the optional ROM 124 instead of starting to boot the operating system 151. If the application program for network booting is executed, the communication unit 110 may be initialized and an IP of a network card or a network chip may be automatically allotted as a specific IP of a private IP area.

Thereafter, a PING message may be transmitted to the external device 200 connected to the communication unit 110 to check whether or not the connection with the external device 200 has been activated. If it is checked that the external device 200 is connected to the communication unit 110, it may be checked whether or not the external device 200 shares its ODD. If the external device 200 shares the ODD, the application program may emulate the shared ODD as a local ODD. Accordingly, the operating system 151 installed in the computer system 100 may be restored (or upgraded) by using a restoring image (or upgrading image) of the operating system from the shared ODD.

In accordance with another exemplary embodiment, the optional ROM 124 may store an application program for a network booting to be executed by the BIOS 1261. The CPU 121 may perform the initialization of the computer system 100 by the BIOS 1261 according to the power-on input. Before starting to boot an operating system 151 installed in the storage 150, i.e., before the start of a booting section of the operating system 151 following the power-on input, if a predetermined key is inputted from a user through the user input unit 130, the BIOS 1261 may instead execute the application program for network booting stored in the optional ROM 124 instead of booting the operating system 151. If the application program for network booting is executed, the communication unit 110 may be initialized and an IP of a network card or a network chip may be automatically allotted as a specific IP of a private IP area.

Then, a PING message may be transmitted to the external device 200 connected to the communication unit 110 to check whether or not the connection with the external device 200 is activated. There can be a determination as to whether or not the external device 200 is connected to the communication unit 110, as well as whether or not the external device 200 shares its ODD. If the external device 200 shares the ODD, the application program may emulate the shared ODD as a local ODD. Accordingly, the computer system 100 may be network-booted by using a booting image of the operating system stored in the shared ODD.

The controller hub 125 may serve as an interface for data transmission between some or all of the CPU 121, the main memory 122, the BIOS memory 124, and the storage 150. The controller hub 125 may include, for example, a north bridge (not shown) for high-speed data transmission, a memory controller hub (MCH) (not shown), a south bridge (not shown) for low-speed data transmission, or an I/O controller hub (ICH) (not shown).

In accordance with the present exemplary embodiment, the storage 150 may be included as described above. The storage 150 may store the operating system of the computer system 100 and be embodied as a hard disk drive. The hard disk drive may be embodied as a nonvolatile memory, e.g., a magnetic disk or a flash memory. In the meantime, an application program for allowing a computer system to perform a specific function may be stored on the hard disk drive.

The computer system 100 of the present exemplary embodiment may further include a power supply 160 for supplying a power to various components of the computer system 100. The power supply 160 may convert an externally inputted typical AC power to an activating power and supply the converted power thereto. The computer system 100 may further include a battery (not shown), which has a predetermined battery capacity and is charged by a power supplied from the power supply 160. The battery may serve as an auxiliary power supply for supplying a power to various components of the computer system 100 for the power supply 160.

In addition, the computer system 100 of the present exemplary embodiment may further include one or more peripheral devices (not shown). The peripheral device(s) may be embodied as a hardware for various functions of the computer system 100, such as a sound card, a speaker, or a microphone.

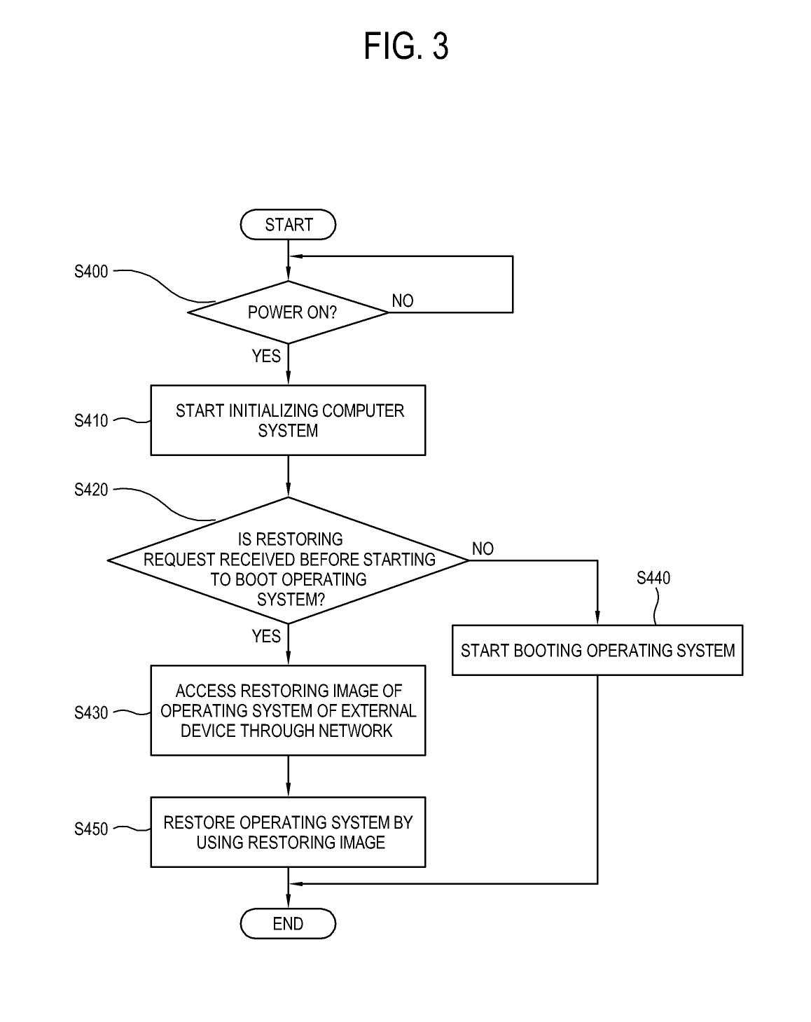

FIG. 3 is a flowchart showing a control process for remotely restoring the operating system in accordance with the exemplary embodiment.

If at (S400) a power-on input is received through the user input unit 130, then at (S410) the computer system 100 starts an initialization routine.

However, if at (S420) a request for restoring the operating system is received from a user (typically via pressing a certain programmed key) prior to starting a boot the operating system after the start of the initialization routine (typically the initialization routine does not immediately boot the system permitting a short time in which the user can activate the restore key) of the computer system 100 is started, then at (S430) computer system 100 may access a restoring image of the operating system stored in the external device 200 through the communication unit 110 which performs the communication with the external device 200.

If no request for restoring the operating system is received (S420), then at (S440) the operating system will typically start being booted. Then, at (S450) the computer system 100 may restore the operating system by using the accessed restoring image of the operating system.

The exemplary control process shown in FIG. 3 may similarly be performed when the operating system is upgraded in accordance with another exemplary embodiment.

If a power-on input is received through the user input unit 130, the computer system 100 may start an initialization. If a request for upgrading the operating system is received from a user prior to starting to boot the operation system after the initialization of the computer system 100 started, the computer system 100 may access an upgrading image of the operating system stored in the external device 200 through the communication unit 110 which performs the communication with the external device 200. If no request for upgrading the operating system is received, the operating system will start to be booted. Then, the computer system 100 may upgrade the operating system by using the accessed upgrading image of the operating system.

The control process shown in FIG. 3 may similarly be performed when the operating system is booted in accordance with still another exemplary embodiment.

If a power-on input is received through the user input unit 130, the computer system 100 may start the initialization. If a predetermined key is input from a user before starting to boot the operation system after the initialization of the computer system 100 is started, the computer system 100 preferably accesses a booting image of the operating system stored in the external device 200 through the communication unit 110 which performs the communication with the external device 200. Accordingly, the computer system 100 performs the booting operation by using the accessed upgrading image of the operating system.

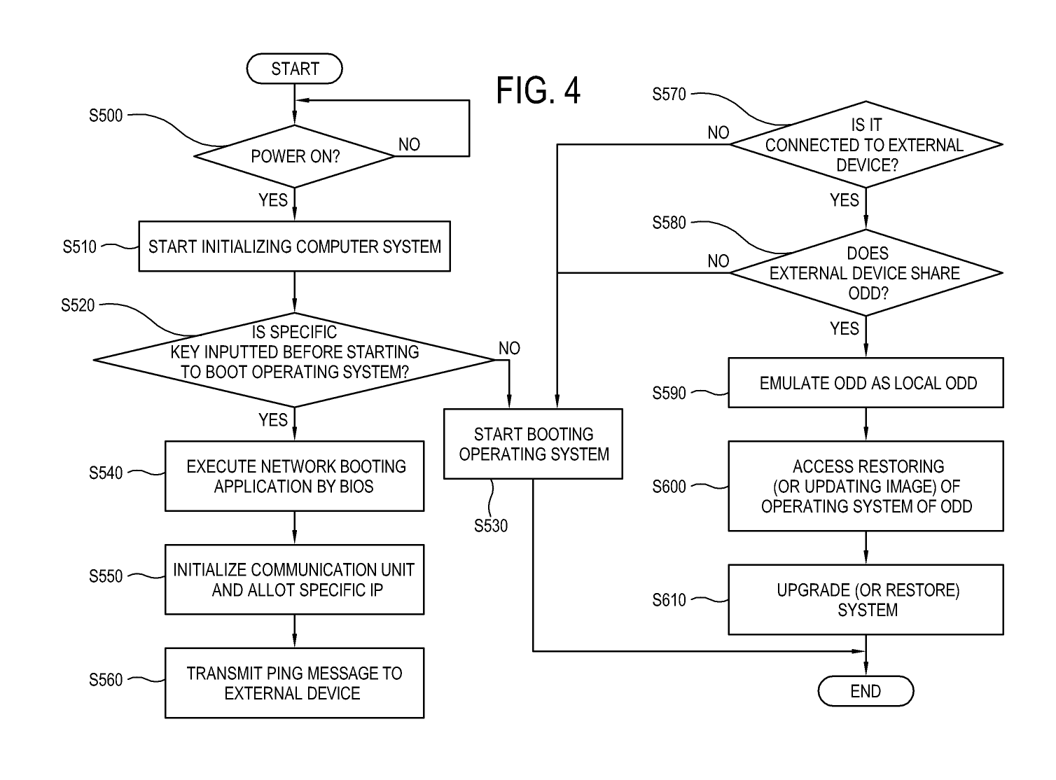

FIG. 4 is a flowchart showing an example of a control process for remotely restoring an operating system in accordance with the exemplary embodiment.

If at (S500) a power-on input is received through the user input unit 130, then at (S510) the computer system 100 typically starts an initialization. If at (S520), a specific key is input through the user input unit 130 before starting to boot the operation system after the initialization of the computer system 100 is started, then at (S540) a network booting application stored in the optional ROM 124 may be executed by the BIOS 1261. If no specific key is input at (S520), then at (S530) the operating system 151 stored in the storage 150 of the computer system 100 starts to be booted.

If the application program is executed, then at (S550) the communication unit 110 of the computer system 100 may be initialized and a specific IP of a private IP area may automatically be allotted. Moreover, at (S560) a PING message may be transmitted to the external device 200 capable of a network communication with the communication unit 110 to check whether or not the external device 200 is actually activated and the network communication is possible (e.g. whether there is a connection) (S570). If the network communication is not possible due to the disconnection with the external device 200, the process may return to the step (S530) to begin booting the operating system.

If at (S580) the network communication is possible due to the connection with the external device 200, the process may check whether or not the ODD of the external device 200 is shared. If it is determined that the ODD of the external device 200 is not shared, the process may return to the step (S530). If it is determined that the ODD of the external device 200 is shared, then at (S590) the ODD may be emulated as a local ODD and at (S600) a restoring image of the operating system stored in the ODD may be accessed. Then, at step (S610) the operating system of the computer system 100 may be restored by using the accessed restoring image.

The control process shown in FIG. 4 may similarly be performed when the operating system is upgraded in accordance with another exemplary embodiment.

All steps S500 to S580 shown in FIG. 4 may identically performed. Accordingly, it can be determined whether or not the ODD of the external device 200 is shared (S580). If an upgrading image of the operating system is stored in the shared ODD, then at (S590) the ODD may be emulated as a local ODD and at (S600) the updating image of the operating system stored in the ODD may be accessed. Then, at (S610) the operating system of the computer system 100 may be upgraded by using the accessed upgrading image.

The control process shown in FIG. 4 may similarly be performed when the operating system is network-booted in accordance with still another exemplary embodiment.

All steps S500 to S580 shown in FIG. 4 may identically performed. Accordingly, it is checked that the ODD of the external device 200 is shared (S580). If a booting image of the operating system is stored in the shared ODD, the ODD may be emulated as a local ODD (S590) and the booting image of the operating system stored in the ODD may be accessed (S600). Then, at (S610) the computer system 100 may be booted by using the accessed booting image.

As described above, in accordance with the exemplary embodiments, it is possible to provide a computer system and a method, capable of remotely restoring an operating system in a computer system having no ODD when the operating system of the computer system is abnormally performed due to an error caused by various reasons.

It is also possible to provide to provide a computer system and a method, capable of remotely upgrading an operating system in a computer system having no ODD when the operating system of the computer system is updated.

It is also possible to provide to provide a computer system and a method, capable of remotely booting an operating system in a computer system having no ODD when the operating system of the computer system is remotely booted.

The above-described methods according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system having an operating system that is remotely restorable, the system including:
a storage unit having the operating system is installed thereon;
a communication unit which communicates with a predetermined external device in which a restoring image of the operating system is stored;
an input unit which receives a user's input; and
a controller which performs an initialization of the computer system according to a power-on input, checks whether or not a request for restoring the operating system is received from a user prior to starting a boot of the operating system installed in the storage unit following the power-on input, and, when the request for restoring the operating system is received, accesses the restoring image of the operating system stored in the external device through the communication unit to restore the operating system installed in the computer system by retrieving the restoring image of the operating system.

2. The computer system of claim 1, wherein said computer system does not include an optical disc drive (ODD).

3. The computer system of claim 1, wherein, upon sensing a predetermined key has been activated, the controller checks whether the request for restoring the operating system is received.

4. The computer system of claim 1, further including: a display unit,
wherein the controller provides an input menu for input of the request for restoring the operating system and controls the display unit to display the formed input menu, and
wherein the controller checks that the request for restoring the operating system is received via input from the displayed input menu.

5. The computer system of claim 1, further including: a display unit,
wherein, when the request for restoring the operating system is received, the controller controls the display unit to display device information related to a said external device in which a restoring image of the operating system is stored.

6. The computer system of claim 1, wherein, when device information related to said external device in which a restoring image of the operating system is stored is input through the input unit, the controller identifies said external device in which a restoring image of the operating system is stored, based on the input device information.

7. A method of remotely restoring an operating system of a computer system, the method comprising:
performing an initialization of the computer system in accordance with a power-on input;
checking whether or not a request for restoring the operating system is received from a user prior to starting a boot of the operating system installed in the computer system following the power-on input;
accessing a restoring image of the operating system stored in the external device through the communication unit when the request for restoring the operating system is received; and
restoring the operating system installed in the computer system by using the restoring image of the operating system.

8. The method of claim 7, wherein the computer system does not include an optical disc drive (ODD).

9. The method of claim 7, wherein the checking comprises determining that the request for restoring the operating system is received when a predetermined key is selected from the user input unit.

10. The method of claim 7, further comprising:
displaying an input menu for inputting the request for restoring the operating system; and
receiving the request for restoring the operating system selected via the displayed input menu.

11. The method of claim 7, wherein the accessing comprises displaying device information related to the external device in which a restoring image of the operating system is stored.

12. The method of claim 7, wherein the accessing comprises determining the external device in which a restoring image of the operating system is stored, based on device information input by a user.

13. A computer system having an operating system that is remotely upgraded, the system including:
a storage in which the operating system is installed therein;
a communication unit which communicates with an external device in which a restoring image of the operating system is stored;
an input unit which receives a user's input; and
a controller which performs an initialization of the computer system according to a power-on input, checks whether or not a request for upgrading the operating system is received from a user prior to starting a boot of the operating system installed in the storage following the power-on input, and, if the request for upgrading the operating system is received, accesses the upgrading image of the operating system stored in the external device through the communication unit to upgrade the operating system installed in the computer system by using the upgrading image of the operating system.

14. The computer system according to claim 13, wherein the computer system does not include an optical disc drive (ODD).

15. A method of remotely upgrading an operating system of a computer system, the method comprising:
performing an initialization of the computer system according to a power-on input;
checking whether or not a request for upgrading the operating system is received from a user prior to starting a boot of the operating system installed in the computer system following the power-on input;
accessing an upgrading image of the operating system stored in an external device through the communication unit if the request for upgrading the operating system is received; and
restoring the operating system installed in the computer system by utilizing the upgrading image of the operating system.

16. The method according to claim 15, wherein the computer system does not include an optical disc drive (ODD).

17. A computer system whose operating system that is remotely booted, the system including:
a storage unit in which the operating system is installed;
a communication unit which communicates with an external device in which a restoring image of the operating system is stored;
an input unit which receives a user's input; and
a controller which performs an initialization of the computer system according to a power-on input, accesses the booting image of the operating system stored in the external device through the communication unit if a predetermined key is input from a user before starting to boot the operating system installed in the storage following the power-on input, and boots the computer system by using the booting image of the operating system stored in the external device.

18. The computer system according to claim 17, wherein the computer system does not include an optical disc drive (ODD).

19. A method of remotely booting an operating system of a computer system, the method comprising:
performing an initialization of the computer system according to a power-on input;
receiving a predetermined key from a user prior to starting a boot the operating system installed in the computer system following the power-on input;
accessing the booting image of the operating system stored in the external device through the communication unit; and
booting the computer system by using the booting image of the operating system stored in the external device.

20. The method according to claim 19, wherein the computer system does not include an optical disc drive (ODD).
